(19) United States
(12) Patent Application Publication
(10) Pub. No.: US 2023/0022483 A1
(43) Pub. Date: Jan. 26, 2023

(54) METHOD FOR REMEDIATING WATER SOURCES AND MIXTURES FORMED FROM THE SAME

(71) Applicant: Brilliant Lab LLC, America Fork, UT (US)

(72) Inventor: Daniel A. Gubler, Ph.D., Orem, UT (US)

(21) Appl. No.: 17/381,779

(22) Filed: Jul. 21, 2021

(51) Int. Cl. C11B 1/02; C11B 3/00

(52) U.S. Cl. CPC C11B 1/025; C11B 3/00

(57) ABSTRACT

Described herein is a method of remediating a water source of a target aquatic life. The method comprises collecting at least one target species of aquatic life from a water source, separating an oil from the solids of the target aquatic life, and refining a polyunsaturated fatty acid (PUFA) mixture from the oil. The water source is at least partially remediated by collecting the at least one target species of aquatic life from the water source.

### TECHNICAL FIELD

The application relates generally to methods for remediating water sources of a target species of aquatic life. Related methods and products derived from the methods described herein are also disclosed.

### BACKGROUND

Invasive species are recognized as harmful species that cause economic damage, potential harm to human health, and decrease biodiversity. The presence of invasive species in water sources has been estimated to cost upwards of $100 billion USD in economic damage per year. (McCormick, Contreras, & Johnson, 2009) Not only does the presence of invasive species disrupt the local food chain among predators and prey, their presence also adversely affects the quality of water. Id. For example, a notable instance of invasive fish species that adversely affected human health was the introduction of Whirling Disease by infected brown trout. Id. Whirling Disease is caused by a parasite, which has proliferated and spread throughout the United States.

Invasive species also adversely affect biodiversity by either competing with other predators for resources or consuming desired species for human use or consumption. The extended presence of invasive species may also alter the local ecosystem, potentially destroying the local ecosystem altogether. Invasive species displace the native species, which contribute to the health and maintenance of the local ecosystem. Degradation of local ecosystems of fish may result in economic damages. Thus, eradicating invasive species has been an ongoing goal for mitigating the harmful effects due to invasive species, while potentially restoring some native habitats. (Norton & Warburton, 2015)

The presence of invasive species may decrease the population of fish and other desired aquatic life. Aquatic life, such as fish, are sought after as a source of omega-3 fats, such as polyunsaturated fatty acids (PUFAs). Fish are particularly nutritious as they contain a relatively high proportion of omega-3 fats that contribute positively to human health in various facets. The benefits of marine omega-3 fats received significant traction when Danish scientists proposed that low incidents of coronary heart disease were observed in Inuit, the indigenous people of Greenland. (Fumagalli, et al., 2015). Omega-3 fats of particular interest as dietary supplements have been PUFAs, such as eicosapentaenoic acid (EPA), alpha-linoleic acid (α-LA), docosahexaenoic acid (DHA), and docosapentaenoic acid (DPA). (Yokotama, et al., 2007), (Dyall, 2015).

Omega-3 fatty acids are obtained predominantly from Peruvian anchovies. Leftover fish parts of salmon, macro, herring, pollock and tuna—byproducts of the fishing industry—are also used. Omega-3 fatty acids can also be obtained from squid, octopus, mussels, clams, and crabs. PUFAs are incorporated into fish and other marine species due to the consumption of algae, phytoplankton, and cyanobacteria in the water. Algae, phytoplankton, and cyanobacteria are capable of synthesizing PUFAs, while other animals, such as fish and humans, cannot synthesize PUFAs.

### BRIEF SUMMARY

Described herein is a method of remediating a water source of invasive species. Invasive species are selected, collected, and preferably separated from other aquatic life in a water source. Processing of invasive species to utilize them as a source of desirable products such as omega-3 fats is a responsible way of utilizing invasive species in the environment as an alternative and additional source of omega-3 fats. Economically, the desirable products may also help to offset the costs of the remediation.

The method is useful as an aid in remediating water sources of invasive species and utilizing the invasive species as a source of fats, particularly omega-3 fats including PUFAs. The extracted omega-3 fats include DHA, DPA, EPA, or a combination thereof. Since invasive species are likely to be removed, the method described herein upcycles the fish products into useful products for consumption or use by humans.

In certain embodiments, the described method involves collecting at least a target species—such as an invasive species—of aquatic life from a water source, separating an oil from the collected aquatic life from solids from the collected aquatic life, and refining a PUFA mixture from the oil. The water source is at least partially remediated by collecting the at least one target species therefrom.

A PUFA mixture produced by the method disclosed is also described.

A method of using a PUFA mixture produced by the method disclosed comprises infusing the PUFA mixture with a gelling agent to produce a nutritional mixture and incorporating the nutritional mixture into a deliverable supplement.

A composition comprising PUFAs produced by the method disclosed is also disclosed. The composition comprises at least one PUFA of DHA, EPA, DPA or a combination thereof, and an anti-oxidant.

A capsule or other dosage form produced by the method disclosed is also disclosed.

A method of treating a subject comprising administering the composition of PUFAs produced by the method disclosed is also disclosed.

### BRIEF DESCRIPTION OF THE FIGURES

FIGS. 1 and 2 depict process flow diagrams for methods described herein.

### DETAILED DESCRIPTION

Invasive species endanger important species of aquatic wildlife that provide important resource, such as essential components in a healthy diet. Disclosed is a method of capitalizing on remediating water sources of invasive species by extracting important nutritional elements/components such as omega-3 fats from invasive species. The omega-3 fats may include polyunsaturated fatty acids (PUFAs), such as docosahexaenoic acid (DHA), eicosapentaenoic acid (EPA), docosapentaenoic acid (DPA), or combinations thereof.

Some have utilized the bones of Asian carp, an invasive species, to fabricate metal sorbent materials, as detailed in U.S. Pub. No. 2020/0147585A1, the contents of which are incorporated herein by reference in its entirety.

As used herein, an “invasive species” depends on a particular ecosystem at hand and the relative population of different species inhabiting the particular ecosystem. An invasive species is defined as “an alien species whose introduction does or is likely to cause economic or environmental harm or harm to human health.” Executive Orders 13112 § 1(f). Whether a species is an invasive species is designated by each State. Widely recognized invasive aquatic life include, but are not limited to, Alosa pseudoharengus, Cyprinus carpio, Monopterus albus, Hypophthalmichthys nobilis, Mylopharyngodon piceus, Lithobates catesbeianus, Rhinella marina, Gymnocephalus cernua, Pylodictis olivaris, Ctenopharyngodon idella, Pterois volitans, Lates niloticus, Channa argus, Myocastor coypus, Colossoma macropomum, Trachemys scripta elegans, Neogobius melanostomus, Petromyzon marinus, and Hypophthalmichthys molitrix among others. (Fish and Other Aquatic Vertebrates, n.d.)

As used herein, an “omega-3 fat” corresponds to a hydrocarbon chain where at least one degree of unsaturation is found at the ω-3 position from the end of the saturated hydrocarbon chain. In effect, the omega-3 fat has a terminal ethyl group. The unsaturated hydrocarbon chain may be covalently bound to a carboxyl group, forming a free omega-3 fatty acid (FA). The unsaturated hydrocarbon chain may be covalently bound to a glycerol, forming a mono-, di-, or triacylglycerol. The unsaturated hydrocarbon chain may be covalently bound as an ethyl ester.

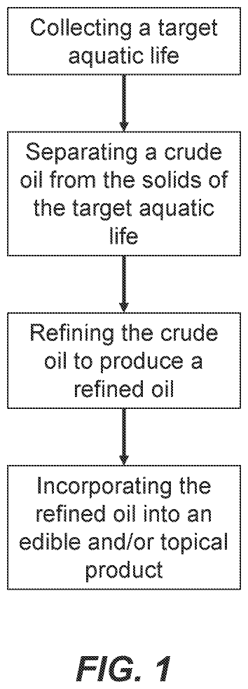

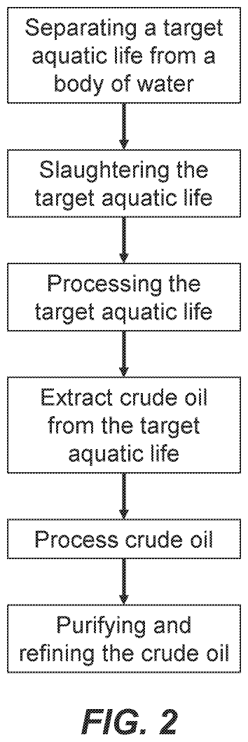

The method, as described in FIG. 1, comprises collecting a target species of aquatic life in a water source. The target species may be an invasive species, as recognized by the United States Department of Fish and Wildlife. In some embodiments, the invasive species may be Cyrpinus carpio, Ctenopharyngodon idella, Cyprinus rubrofuscus, Hypophthalmichthys molltrix, Hypophthalmichthys harmandi, Hypophthalmichthys nobilis, Mylopharyngodon piceus, Carassius auratus, Carassius carassius, Cirrhinus molitorella, Channa argus, Lota lota, Ictalurus punctatus, Pterosis volitans, Pterosis miles, Clarias batrachus, Lates niloticus, Salmo trutta, Oncorhynchus mykiss, Micropterus salmoides, Oreochromis mossambicus, Dreissena polymorpha, Orconectes rusticus, Corbicula fluminea, Alosa pseudoharengus, Gymnocephalus cernua, Neogobius melanostomus, Petromyszon marinus, or a combination of any thereof.

Additionally, collecting a target species of aquatic life may include, but is not limited to, purse seine, trawling, bottom trawling, midwater trawling, gillnet, longlines, pole-and-line, dredge, traps and pots, and diving. These methods of collecting a species of aquatic wildlife are well known in the art, and thus not described in detail here.

Processing the collected aquatic life may involve separating an oil from the collected aquatic life from the solids of the collected aquatic life. The collected aquatic life is slaughtered to yield a carcass. The carcass undergoes cooking, extrusion, pressing, or a combination thereof to yield a meal of solids. As disclosed in U.S. Pat. No. 2,497,367 (the entirety of which is incorporated herein by reference), fatty fish, such as herring, may be heated in hot water or steam and pressed to separate the oil and fats from the aqueous phase and solids. Another method involves initially heating the carcass under vacuum to remove water from the carcass then pressing the carcass to separate the oil and fat from the solids. In another method, cooking involves passing the carcass through a commercial cooker equipped with a screw conveyor (or “Auger conveyor”) that grinds the carcass into smaller pieces. The smaller pieces may be fed into a pressing apparatus to separate the oil and aqueous phases, as described in U.S. Pat. No. 2,536,345 and Australian Pat. Pub. No. AU2018/233468B2, the contents of each are incorporated herein by reference in their entirety.

In some embodiments, the method may further comprise a step of subjecting the obtained oil to saponification, acidification, or a combination thereof. The smaller pieces afforded by passing the carcass through a screw conveyor may be treated with a caustic alkali or caustic alkaline solution such as potash, sodium hydroxide, mixtures thereof, among others, to afford an alkaline product. The alkaline product may be treated with an acidic solution such as sulfuric acid, phosphoric acid, or mixtures thereof to neutralize the alkaline product. The processing steps may favor the production of triglycerides, as described in U.S. Pat. No. 4,554,107 (the contents of which are incorporated herein by reference in its entirety), while also deodorizing the obtained oil.

The obtained oil may be further processed by refining a polyunsaturated fatty acid (PUFA) mixture from the obtained oil. Such refining (i.e., purification) steps may include, but are not limited to, at least one of molecular distillation, vacuum distillation, urea complexation, supercritical fluid extraction, lipase hydrolysis, or a combination thereof. These processes are highlighted in Masqood et al., the entirety of which is incorporated herein by reference, and briefly discussed below.

Separating an oil from the collected aquatic wild life from solids may involve further processing such as crude refinement and deodorization, which involves removing alcohols, aldehydes, ketones, and other odorous compounds. One method of deodorizing mixtures rich in PUFAs is described in U.S. Pat. No. 4,915,876, the entirety of which is incorporated by reference. Odorous compounds are relatively more volatile than the omega-3 components in the purified oil. Thus, treating the purified oil with mild acid and base solutions, followed by subsequent distillations removes the volatile components sooner than the less volatile components, such as omega-3 fats.

In some embodiments, the obtained oil may be refined by molecular distillation. By non-limiting example, the volatile components may be collected using a centrifugal falling-film type distillation apparatus, which heats the obtained oil under vacuum. The volatile components, such as impurities, are removed.

In some embodiments, the obtained oil may be refined by vacuum distillation. By non-limiting example, the obtained oil may be heated in a vessel under vacuum to yield a first distilled oil that has a higher purity of fats, such as omega-3 fats, than the obtained oil. The first distilled oil may be subjected to another round of vacuum distillation to yield a second distilled oil that has a higher purity of fats, such as omega-3 fats, than the first distilled oil, as described in U.S. Pat. No. 10,196,583 (the contents of which are incorporated herein by reference in its entirety).

In some embodiments, the obtained oil may be refined by crystallization by heating and cooling the fish oil. The saturated fats crystallize at relatively higher temperatures as compared to the unsaturated fats. Thus, the solids of saturated fats may be separated from the oily component that contains primarily omega-3 fats (unsaturated fats) for further refinement, as described in U.S. Pat. No. 6,190,715, the contents of which are incorporated herein by reference in its entirety.

In some embodiments, the obtained oil may be refined by urea complexation. Polyunsaturated and monounsaturated fats tend to aggregate with each other as the amount of urea increases with corresponding decreases in temperature. (Liu, Zhang, Hong, & Ji, 2006) (Guil-Guerrero & Belarbi, 2001). By non-limiting example, 10 grams of obtained oil may be treated with 10% (w/v) urea in 95% aqueous ethanol to form a solution that is heated to from about 60 to about 70° C. until the solution becomes clear. The hot solution may then be cooled to room temperature or colder to allow crystallization to occur. In the urea crystals may be separated and the remaining solution, such as a mother liquor, contains the FA-rich non-urea component. The FA-rich non-urea component may then be diluted by an equal volume of water to form an emulsion, where pH of the mixture may be acidified to a pH of about 2 to about 3 using 6 M H₂SO₄. The organic phase containing the liberated FAs may be extracted using hexane, washed with distilled water, and dried over anhydrous Na₂SO₄. Excess hexane may be removed under vacuum to yield a refined oil of omega-3 fatty acids. In some embodiments, the urea crystals may have bound fatty acids that may be recovered by dissolving the solids in hexane, washing the reconstituted fatty acids with deionized water, and drying the fatty acids in hexane over anhydrous Na₂SO₄. Excess hexane may be removed under vacuum to yield a separate refined oil of omega-3 fatty acids. In some embodiments, the purity of the refined oil may be determined using gas-phase chromatography (GC).

In some embodiments, the obtained oil may be refined by supercritical fluid extraction, such as using supercritical carbon dioxide as described in U.S. Pat. No. 4,692,280, the contents of which are incorporated herein by reference in its entirety. By non-limiting example, the supercritical fluid extraction apparatus may be configured to perform at least two extractions. The apparatus is heated to roughly 80° C. and 4000 psi. Odorous components, such as auto-oxidation products, are separated from the omega-3 fats and found in the first fractions from the apparatus. The pressure increases to roughly 7000 psi, and the fractions yielded at the higher pressures contain a higher portion of the omega-3 fats without the odorous components. The fractions yielded correspond to a refined oil.

In some embodiments, the obtained oil may be refined by subjecting the obtained oil to lipase hydrolysis, as described in European Patent 0862369 (WO 1997/019601). By non-limiting example, the obtained oil may be mixed with a lipase to hydrolyze triglycerides into free fatty acids (FFAs). Lipases may include a 1,3-regioselective triacylglycerol (TAG) lipase, a lipase selective for monoacylglycerides (MAG), a lipase selective for diacylglycerides (DAG), a lipase selective for TAG, or a combination thereof.

In the purified oil, omega-3 fats may be present as the triglyceride form, free fatty acid form, ethyl ester form, or a mixture thereof. Specialized pro-resolving mediators (SPMs) may also be present in the purified oil, where the SPMs are formed as a byproduct of PUFA metabolism by lipoxygenase, cyclooxygenase, cytochrome P450, among other enzymes in the target aquatic life. (Basil & Levy, 2016)

The refined oil may comprise a higher proportion of PUFAs than other components such that the refined oil is a PUFA mixture.

In some embodiments, an antioxidant may be added to the PUFA mixture. The antioxidant may be a synthetic or natural antioxidant. Antioxidants decrease the rate at which PUFAs auto-oxidize. Synthetic antioxidants may include, but are not limited to, butylated hydroxyanisole (BHA), butylated hydroxytoluene (BHT), or mixtures thereof as described in U.S. Pat. No. 4,915,876 (the contents of which are incorporated by reference herein in its entirety). Natural antioxidants may include, but are not limited to, mixed tocopherols, caffeic acids, flavonoids, flavonol glycosides, or combinations thereof, as mentioned in Masqood et al. In some embodiments, the flavonoid is a flavonol, such as quercetin, resveratrol, rutin, or a combination thereof. In some embodiments, the flavonol glycoside may be a flavonol derived from citrus, such as hesperidin.

A method of using a PUFA mixture produced by the method described above may comprise infusing the PUFA mixture with a gelling agent to produce a nutritional mixture, and incorporating the nutritional mixture into a deliverable supplement. The gelling agent may include, but is not limited to, pectin, xanthan gum, gelatin, beeswax, carrageenan, carnauba wax, sucrose oligoesters, castor oil, propylene glycol, gum Arabic, polyethylene glycol, or a combination thereof.

In some embodiments, the deliverable supplement is a capsule, tablet, softgel, gel, topical cream, serum, lotion, emulsion, cleaner, toner, transdermal patch, drink powder, powdered sachet, bulk powder, powder encapsulated in nanoparticles, micelles, or a combination thereof.

In some embodiments, incorporating the nutritional mixture into a deliverable supplement comprises incorporating the nutritional mixture into a formulation for nutritional supplements, pharmaceutical drugs, pet products, cosmetic products, infant formulas, fortified milk, butter, margarine, or a combination thereof.

A composition comprising PUFAs produced by the method described above is also described herein. The composition comprises at least one polyunsaturated fatty acid (PUFA) of DHA, EPA, DPA, or a combination thereof, and an antioxidant. The antioxidants present in the composition are as described above.

The composition may be used in a method of treatment, the method comprising administering to a person in need of treatment, where the composition is as described above. The method of treatment may address a condition selected from the group consisting of anxiety, depression, macular degeneration, Alzheimer's disease, memory recall, task switching, long-term memory, prenatal nutrition, infant nutrition, heart disease, blood pressure, stroke, blood clots, inflammation, ADHD, obsessive compulsive disorder, metabolic syndrome, autoimmune diseases, bipolar disorder, schizophrenia, violent behavior, mood swings, type I or type II diabetes, multiple sclerosis, lupus, rheumatoid arthritis, arthritis, cancers, asthma, fatty liver disease, osteoporosis, joint pain, pre-menstrual syndrome, menopause, insomnia, eczema, skin disorders, and any combination thereof.

### REFERENCES

(The contents of each of which are incorporated herein by this reference.)
Basil, M. C., & Levy, B. D. (2016, January). Specialized pro-resolving mediators: endogenous regulators of infection. Nature Reviews: Immunology, 16, 51-67.
Dyall, S. C. (2015, April 21). Long-chain omega-3 fatty acids and the brain: a review of the independent and shared effects of EPA, DPA and DHA. Frontiers in Aging Neuroscience, 7, 1-15.
Fish and Other Aquatic Vertebrates. (n.d.). Retrieved from National Invasive Species Information Center: https://www.invasivespeciesinfo.gov/aquatic/fish-and-other-vertebrates
Fumagalli, M., Moltke, I., Grarup, N., Racimo, F., Bjerregaard, P., Jorgensen, M. E., . . . Nielsen, R. (2015, Sep. 18). Greenlandic Inuit show genetic signatures of diet and climate adaptation. Science, 349(6254), 1343-1347.
Guil-Guerrero, J., & Belarbi, E.-H. (2001). Purification Process for Cod Liver Oil Polyunsaturated Fatty Acids. Journal of the American Oil Chemists' Society, 78(5), 477-484.
Liu, S., Zhang, C., Hong, P., & Ji, H. (2006). Concentration of docosahexaenoic acid (DHA) and eicosapentaenoic acid (EPA) of tuna oil by urea complexation: optimization of process parameters. Journal of Food Engineering, 73, 203-209.
Norton, D. A., & Warburton, B. (2015). The potential for biodiversity offsetting to fund effective invasive species control. Conservation Biology, 29(1), 5-11.
Yokotama, M., Origasa, H., Matsuzaki, M., Matsuzawa, Y., Saito, Y., Ishikawa, Y., . . . Shirato, Kunio. (2007, March 31). Effects of eicosapentaenoic acid on major coronary events in hypercholesterolaemic patients (DELIS): a randomised open-label, blinded endpoint analysis. Lancet, 369(9567), 1090-1098.

1. A method of remediating a water source of invasive species, the method comprising:
collecting at least one target species of aquatic life from the water source;
separating an oil from the collected aquatic life from solids from the collected aquatic life; and
refining a polyunsaturated fatty acid (PUFA) mixture from the oil,
wherein the water source is at least partially remediated by collecting the at least one target species therefrom.

2. The method according to claim 1, further comprising purifying omega-3 fat in the PUFA mixture.

3. The method according to claim 2, wherein the omega-3 fat comprises docosahexaenoic acid (DHA), eicosapentaenoic acid (EPA), docosapentaenoic acid (DPA), or a combination thereof.

4. The method according to claim 1, wherein collecting at least one target species of aquatic life comprises harvesting at least one of Cyrpinus carpio, Ctenopharyngodon idella, Cyprinus rubrofuscus, Hypophthalmichthys molltrix, Hypophthalmichthys harmandi, Hypophthalmichthys nobilis, Mylopharyngodon piceus, Carassius auratus, Carassius carassius, Cirrhinus molitorella, Channa argus, Lota lota, Ictalurus punctatus, Pterosis volitans, Pterosis miles, Clarias batrachus, Lates niloticus, Salmo trutta, Oncorhynchus mykiss, Micropterus salmoides, Oreochromis mossambicus, Dreissena polymorpha, Orconectes rusticus, Corbicula fluminea, or a combination thereof from the water source.

5. The method according to claim 1, wherein collecting the at least one target species of aquatic life comprises pure seining, bottom trawling, midwater trawling, gillnetting, long lining, pole-and-lining, dredging, using traps-and-pots, and diving.

6. The method according to claim 1, wherein refining PUFA mixture comprises processing the collected aquatic life by extrusion, crude refinement, deodorization, and molecular distillation, or a combination thereof.

7. The method according to claim 6, wherein refining a PUFA mixture comprises removing odorous compounds of aldehydes, ketones, alcohols, or a combination thereof in the PUFA mixture.

8. The method according to claim 1, further comprising incorporating an antioxidant into the PUFA mixture.

9. A polyunsaturated fatty acid (PUFA) mixture produced by the method of claim 1.

10. A method of using a polyunsaturated fatty acid (PUFA) mixture produced by the method of claim 1, the method comprising:
infusing the PUFA mixture with a gelling agent to produce a nutritional mixture, and
incorporating the nutritional mixture into a deliverable supplement.

11. The method according to claim 10, wherein the deliverable supplement is a capsule, tablet, softgel, gel, topical cream, serum, lotion, emulsion, cleaner, toner, transdermal patch, drink powder, powdered sachet, bulk powder, powder encapsulated in nanoparticles, micelles, or a combination thereof.

12. The method according to claim 10, wherein incorporating the nutritional mixture comprises incorporating the nutritional mixture into a formulation for nutritional supplements, pharmaceutical drugs, pet products, cosmetic products, infant formulas, fortified milk, butter, margarine, or a combination thereof.

13. A composition comprising PUFAs produced by the method of claim 1, the composition comprising:
at least one polyunsaturated fatty acids (PUFAs) of docosahexaenoic acid (DHA), eicosapentaenoic acid (EPA), docosapentaenoic acid (DPA), or a combination thereof; and
an anti-oxidant.

14. A capsule produced by the method according to claim 11.

15. A method of treating a subject in need thereof, the method comprising:
administering to the subject the composition of claim 13.

16. The method according to claim 15, wherein the composition is administered to the subject to treat a condition selected from the group consisting of anxiety, depression, macular degeneration, Alzheimer's disease, memory recall, task switching, long-term memory, prenatal nutrition, infant nutrition, heart disease, blood pressure, stroke, blood clots, inflammation, ADHD, obsessive compulsive disorder, metabolic syndrome, autoimmune diseases, bipolar disorder, schizophrenia, violent behavior, mood swings, type I or type II diabetes, multiple sclerosis, lupus, rheumatoid arthritis, arthritis, cancers, asthma, fatty liver disease, osteoporosis, joint pain, pre-menstrual syndrome, menopause, insomnia, eczema, skin disorders, and any combination thereof.
